(19) United States
(12) Patent Application Publication
(10) Pub. No.: US 2026/0155922 A1
(43) Pub. Date: Jun. 4, 2026

(54) SYSTEMS, METHODS, APPARATUSES, AND NON-TRANSITORY COMPUTER-READABLE MEDIA FOR TRANSMISSION MULTIPLEXING

(71) Applicant: ZTE CORPORATION, Shenzhen (CN)

(72) Inventors: Xing LIU, Shenzhen (CN); Xianghui HAN, Shenzhen (CN); Xingguang WEI, Shenzhen (CN); Junfeng ZHANG, Shenzhen (CN); Jing SHI, Shenzhen (CN); Shuaihua KOU, Shenzhen (CN)

(73) Assignee: ZTE CORPORATION, Shenzhen (CN)

(21) Appl. No.: 19/378,938

(22) Filed: Nov. 4, 2025

Related U.S. Application Data
(63) Continuation of application No. PCT/CN2023/108732, filed on Jul. 21, 2023.

(51) Int. Cl. H04L 5/00; H04W 72/0446; H04W 76/40

(52) U.S. Cl. CPC H04L 5/0044; H04W 72/0446; H04W 76/40

(57) ABSTRACT

The present disclosure is directed to transmission source indication, including receiving, by a wireless communication device from a network, information indicating that at least a part of frequency domain resource of at least one of a Downlink (DL) resource or a flexible resource is configured as an Uplink (UL) resource, determining, by the wireless communication device based on the information, a cancelation resource indication set, and receiving, by the wireless communication device from the network, an indication of a cancelation resource within the cancelation resource indication set.

### CROSS-REFERENCE TO RELATED APPLICATION

This application claims the benefit of priority under 35 U.S.C. § 120 as a continuation of PCT Patent Application No. PCT/CN2023/108732, filed on Jul. 21, 2023, the disclosure of which is incorporated herein by reference in its entirety.

### TECHNICAL FIELD

The disclosure relates generally to wireless communications and, more particularly, to systems, methods, apparatuses, and non-transitory computer-readable media for transmission multiplexing.

### BACKGROUND

Fourth Generation mobile communication technology (4G) Long-Term Evolution (LTE) or LTE-Advance (LTE-A) and the 5th Generation mobile communication technology (5G) face increasing performance demands. In view of these developing demands and trends, it is desired that 4G and 5G systems support features of Enhanced Mobile Broadband (eMBB), Ultra-Reliable Low-Latency Communication (URLLC), and Massive Machine-Type Communication (mMTC). Further, it is further desired to include full duplex communication in 5G and further communication systems.

### SUMMARY

Some arrangements relate to systems, methods, apparatuses, and non-transitory computer-readable media for receiving, by a wireless communication device from a network, information indicating that at least a part of frequency domain resource of at least one of a Downlink (DL) resource or a flexible resource is configured as an Uplink (UL) resource, determining, by the wireless communication device based on the information, a cancelation resource indication set, and receiving, by the wireless communication device from the network, an indication of a cancelation resource within the cancelation resource indication set.

Some arrangements relate to systems, methods, apparatuses, and non-transitory computer-readable media for receiving, by a wireless communication device from a network, information indicating that at least a part of frequency domain resource of at least one of an UL resource or a flexible resource is configured as a DL resource, determining, by the wireless communication device based on the information, a preemption resource indication set; and receiving, by the wireless communication device from the network, an indication of a preemption resource within the preemption resource indication set.

The above and other aspects and their arrangements are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example wireless communication system, in which techniques disclosed herein may be implemented, in accordance with some arrangements.

FIG. 2 illustrates block diagrams of an example base station and an example user equipment device, in accordance with some arrangements.

FIG. 3 is a schematic diagram illustrating an example of a semi-static frame structure, according to various arrangements.

FIG. 4 is a schematic diagram illustrating an example of a semi-static frame structure, according to various arrangements.

FIG. 5 is a schematic diagram illustrating time-domain sub-blocks of a cancelation resource indication set, according to various arrangements.

FIG. 6 is a flowchart diagram illustrating an example method for indicating UL cancelation resource, according to various arrangements.

FIG. 7 is a schematic diagram illustrating an example of a semi-static frame structure, according to various arrangements.

FIG. 8 is a schematic diagram illustrating an example of a semi-static frame structure, according to various arrangements.

FIG. 9 is a schematic diagram illustrating an example of a semi-static frame structure, according to various arrangements.

FIG. 10 is a schematic diagram illustrating an example of a semi-static frame structure, according to various arrangements.

FIG. 11 is a schematic diagram illustrating an example of a semi-static frame structure, according to various arrangements.

FIG. 12 is a diagram illustrating an example cancelation resource indication set, according to various arrangements.

FIG. 13 is a diagram illustrating an example cancelation resource indication set, according to various arrangements.

FIG. 14 is a diagram illustrating an example cancelation resource indication set, according to various arrangements.

FIG. 15 is a flowchart diagram illustrating an example method for indicating UL cancelation resource, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

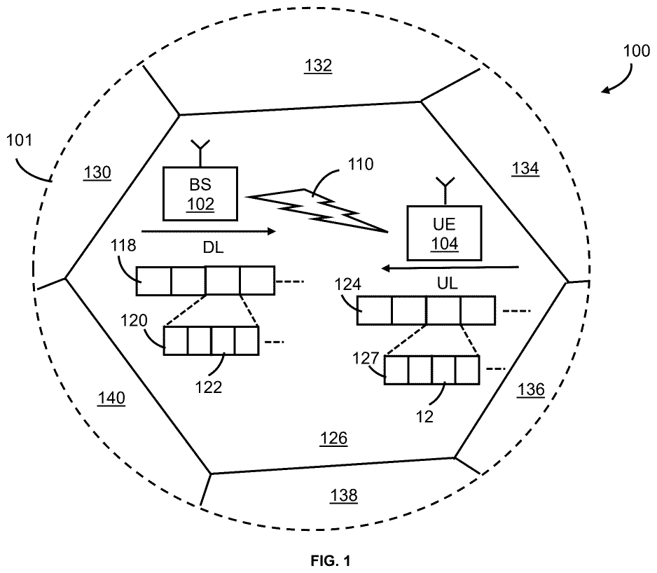

FIG. 1 illustrates an example wireless communication system 100, in accordance with an arrangement of the present disclosure. The wireless communication system 100 may be any wireless network, such as a cellular network or a narrowband Internet of things (NB-IoT) network. The system 100 includes a Base Station (BS) 102 and a User Equipment (UE) 104 that can communicate with each other via a communication link 110 (e.g., a wireless communication channel), and a cluster of cells 126, 130, 132, 134, 136, 138 and 140 overlaying a geographical area 101. In FIG. 1, the BS 102 provides wireless communications and services within the geographic boundary of cell 126, and the UE 104 is located within the area 101. Each of the other cells 130, 132, 134, 136, 138 and 140 may include at least one BS (such as the BS 102) operating at its allocated bandwidth to provide adequate radio coverage to its intended users.

For example, the BS 102 can operate at an allocated channel transmission bandwidth to provide adequate coverage to the UE 104. The BS 102 and the UE 104 may communicate via a Downlink (DL) radio frame 118 and an Uplink (UL) radio frame 124, respectively. Each radio frame 118 or 124 may be further divided into sub-frames 120 or 127, respectively, which may include data symbols 122 or 128, respectively. The BS 102 and UE 104 can be examples of communication nodes generally, which can practice the methods disclosed herein. Such communication nodes may be capable of wireless and/or wired communications, in accordance with various arrangements of the present solution.

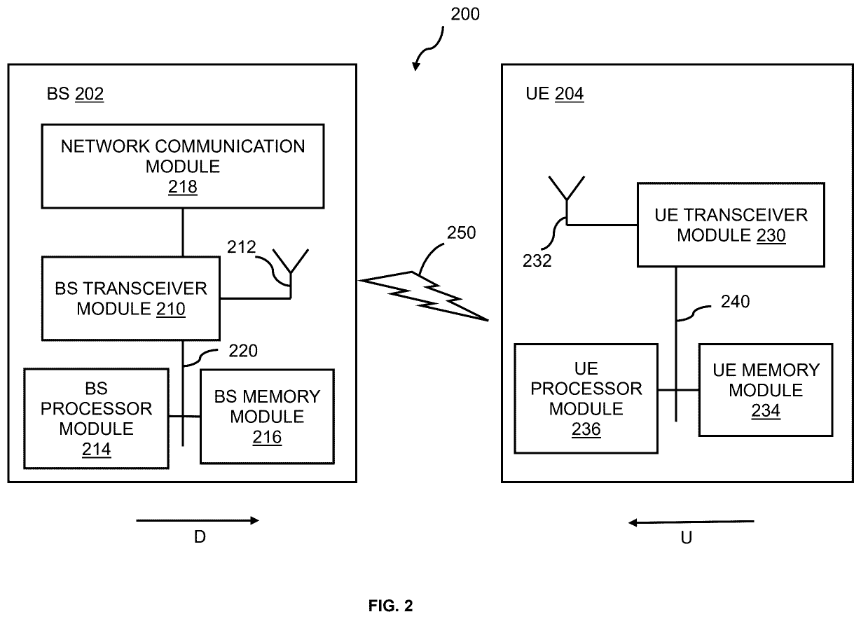

FIG. 2 illustrates a block diagram of an example wireless communication system 200 for transmitting and receiving wireless communication signals, e.g., Orthogonal Frequency Division Multiplexing (OFDM)/Orthogonal Frequency Division Multiple Access (OFDMA) signals, in accordance with some arrangements of the present solution. The system 200 may include components and elements configured to support known or operating features that need not be described in detail herein. In some arrangements, system 200 can be used to communicate (e.g., transmit and receive) data or signals in a wireless communication environment such as the wireless communication system 100 of FIG. 1. System 200 generally includes a BS 202 and a UE 204. The BS 202 is an example of the BS 102. The UE 204 is an example of the UE 104.

The BS 202 includes a BS transceiver module 210, a BS antenna 212, a BS processor module 214, a BS memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

The system 200 may further include any number of modules other than the modules shown in FIG. 2. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some arrangements, the UE transceiver 230 may be referred to herein as an UL transceiver 230 that includes a radio frequency (RF) transmitter and a RF receiver each comprising circuitry that is coupled to the antenna 232. A duplex switch (not shown) may alternatively couple the UL transmitter or receiver to the UL antenna in time duplex fashion. Similarly, in accordance with some arrangements, the BS transceiver 210 may be referred to herein as a DL transceiver 210 that includes a RF transmitter and a RF receiver each comprising circuity that is coupled to the antenna 212. A DL duplex switch may alternatively couple the DL transmitter or receiver to the DL antenna 212 in time duplex fashion. The operations of the two transceiver modules 210 and 230 can be coordinated in time such that the UL receiver circuitry is coupled to the UL antenna 232 for reception of transmissions over the wireless transmission link 250 at the same time that the DL transmitter is coupled to the DL antenna 212. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G, 6G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the BS 202 may be an gNB, evolved node B (eNB), a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

In the example wireless communication system 100, the TDR is split between DL and UL in Time-Division Duplex (TDD). Allocation of a limited time duration for the UL in TDD can result in reduced coverage, increased latency, and reduced capacity. Simultaneous existence of DL and UL, e.g., full duplex, or more specifically, Subband Non-overlapping Full Duplex (SBFD) at the BS side within a TDD band, can be advantageous.

In some examples, at least a part or a portion of a FDR can be configured as an UL resource, e.g., an UL subband, within a semi-static DL resource or a flexible (special) resource. In some examples, at least a part or a portion of a FDR can be configured as DL resource, e.g., a DL subband, within a semi-static UL resource or a flexible (special) resource. Accordingly, there can be both of UL and DL in different FDRs of a same TDR.

Using a transmissions multiplexing mechanism between different UEs, part of DL/UL transmission resource allocated to a first UE for receiving/transmitting a DL/UL transmission can be preempted/canceled by another DL/UL transmission with a higher priority to/from a second UE. The indication of DL preemption resource or UL cancelation resource does not consider the resource allocation feature in full-duplex mode. Accordingly, the arrangements described herein enable transmissions multiplexing mechanism between different UEs under the full duplex system.

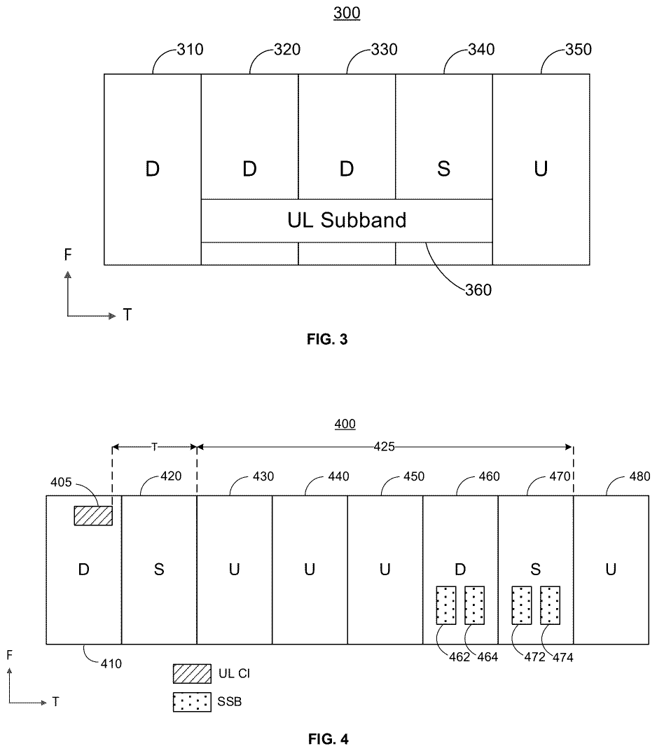

FIG. 3 is a schematic diagram illustrating an example of a semi-static frame structure 300, according to various arrangements. The semi-static frame structure 300 can be used by multiple UEs (e.g., the UE 104) within a same cell (e.g., the cell 126) under a BS (e.g., the BS 102). The semi-static frame structure 300 includes resources 310, 320, 330, 340, and 350. Each of the resources 310, 320, 330, 340, and 350 has a TDR along the horizontal axis denoted T and a FDR along the vertical axis denoted F. As shown, the semi-static frame structure 300 is configured as “DDDSU.” For example, “D” represents a DL resource (e.g., a DL slot, frame, subframe, etc.), “U” represents an UL resource (e.g., a UL slot, frame, subframe, etc.), and “S” represents a flexible or special resource (e.g., a flexible or special slot, frame, subframe, etc.). A flexible resource can be further updated according to dynamic scheduling or dynamic frame structure indication (e.g., a Slot Format Indicator (SFI)). That is, the resources 310, 320, and 330 are configured for DL transmissions from the BS 102 to the UEs, the resource 350 is configured for UL transmissions from the UEs to the BS 102, and the resource 340 can be configured as either DL or UL resource.

A portion of the FDR of the resources 320, 330, and 340 are configured with an UL subband 360. The BS 102 can transmit DL transmissions (e.g., Physical Downlink Shared Channels (PDSCHs)) to the different UEs and receive UL transmissions (e.g., Physical Uplink Shared Channels (PUSCHs) from the different UEs simultaneously using the UL subband 360.

Wireless communication services have different priorities. To provide improved quality, e.g., shorter delay and higher reliability, for high-priority services, an inter-UE multiplexing mechanism can be used for both UL and DL. More specifically, a transmission resource of the UE 104 may be preempted or canceled by a higher-priority service of another UE within the cell 126. To implement objectives of preemption and cancelation, certain DCI formats are defined. For example, for UL cancelation, one piece or portion of DCI format, e.g., DCI format 2_4, is sent by the BS 102 to the UE 104 in advance of the canceled UL transmission of the UE 104, to prevent the UE 104 from sending an originally scheduled service on the canceled resource. For DL, the BS 102 may change some resources originally allocated to a first UE (e.g., the UE 104) for service transmission to send a service with a higher priority of a second UE. The BS 102 can send another DCI format, e.g., DCI format 2_1, to indicate to first UE that the transmission resource has been preempted. The first UE can enjoy improved better performance when decoding data based on the understanding that the part of the transmission resources are preempted.

In some cases, the cancelation resource or preemption resource (e.g., canceled or preempted resource) needs to be indicated by the BS 102 to the UE 104 in a resource set with a corresponding resource attribute. For example, for the UL inter-UE multiplexing, the BS 102 indicates the UL cancelation resource in a cancelation resource indication set, which excludes a resource configured as a semi-static DL resource and a resource configured as an SSB transmission resource from a configured or defined time-domain duration of the cancelation resource indication set.

FIG. 4 is a schematic diagram illustrating an example of a semi-static frame structure 400, according to various arrangements. The semi-static frame structure 400 can be used by multiple UEs (e.g., the UE 104) within a same cell (e.g., the cell 126) under a BS (e.g., the BS 102). The semi-static frame structure 400 includes resources 410, 420, 430, 440, 450, 460, 470, and 480. Each of the resources 410, 420, 430, 440, 450, 460, 470, and 480 has a TDR along the horizontal axis denoted T and an FDR along the vertical axis denoted F. As shown, the semi-static frame structure 400 is configured as “DSUUU”. That is, the resources 410 and 460 are configured for DL transmissions from the BS 102 to the UEs, the resources 430, 440, 450, and 480 are configured for UL transmissions from the UEs to the BS 102, and the resources 420 and 470 can be configured as either flexible resources.

The BS 102 can be configured to transmit an UL Cancelation Indication (UL CI) 405 (e.g., DCI format 2_4) to the UE 104 in a DL slot in the resource 410. The starting point of the corresponding time-domain duration or range 425 for indicating the UL cancelation resource is a time period T after the end of the UL CI 405. The length of the configured time-domain duration 425 is 5 slots (e.g., the resources 430, 440, 450, 460, and 470) in some examples. The TDR for each of the resources 410, 420, 430, 440, 450, 460, 470, and 480 is a slot.

The BS 102 can be scheduled to transmit SSB transmissions to the UE 104 in resources 462, 464, 472, and 474 (e.g., symbols), within the resources 460 and 470, respectively. A semi-static DL resource 460 (e.g., the fourth slot within the configured time-domain duration 425) and symbols (e.g., the resources 472 and 474) configured as SSB transmissions (e.g., the SSB symbols within the resource 470 which is the fifth slot of the configured time-domain duration 425) within the time-domain duration 425 can be excluded from the cancelation resource indication set. The cancelation resource indication set includes the first three slots (e.g., the resources 430, 440, and 450) and the TDRs (e.g., symbols) in the fifth slot (e.g., the resource 470) after excluding the SSB symbols (e.g., the resources 472 and 474). Similarly, for the DL inter-UE multiplexing, the DL preemption resource also needs to indicate in a preemption resource indication set, which needs to exclude a resource configured as semi-static UL.

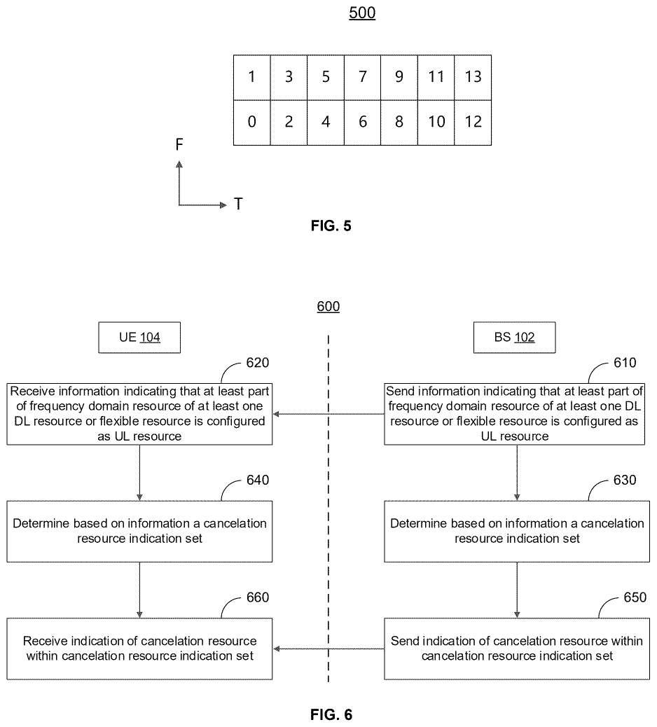

Further, the cancelation resource indication set can be further divided into multiple time-frequency domain resource sub-blocks according to a predefined rule and/or indication information. FIG. 5 is a schematic diagram illustrating time-domain sub-blocks of a cancelation resource indication set 500, according to various arrangements.

The BS 102 can configure to the UE 104 a number of time-domain sub-blocks (e.g., 7 in FIG. 5) via Radio Resource Control (RRC) signaling. The BS 102 can configure to the UE 104 a number of bits (e.g., 14 bits in FIG. 5) in the UL CI (e.g., the UL CI 405) for each carrier. The number of frequency-domain sub-blocks for each time-domain sub-block can be determined by the number of bits divided by the number of time-domain sub-blocks (e.g., 14/7=2 in FIG. 5). The cancelation resource indication set is divided into 14 time-frequency domain resource sub-blocks with indices 0-13, as shown in FIG. 5. Each time-frequency domain resource sub-block can map to a respective bit in the UL CI. The value of bit in the UL CI represents whether the corresponding time-frequency domain resource sub-block is canceled (e.g., 0 indicates canceled and 1 indicates not canceled, or 0 indicates not canceled and 1 indicates canceled).

The UE 104 detects a UL CI received from the BS 102 and determines that the canceled time-frequency domain resource sub-block overlaps with a transmission resource scheduled for the UE 104 at an overlapping part. In response, the UE 104 cancels its transmission from the starting point of the overlapping part. In some examples, there are one or more indication blocks in one UL CI. Each indication block corresponds to a carrier or cell for indicating cancelation resource within a cancelation resource indication set of this carrier or cell.

For subband full duplex, a part of FDR within a semi-static DL resource can be configured the UL resource (e.g., the UL subband 360). However, a cancellation resource cannot be indicated in the UL subband within the semi-static DL resource because the semi-static DL resource has been excluded from the cancelation resource indication set. Similarly, the preemption resource cannot be indicated in the DL subband in the semi-static UL resource because the semi-static UL resource is already excluded from the preemption resource indication set.

The arrangements disclosed herein enable transmissions multiplexing mechanism between different UEs under the full duplex system. The methods by which the UL cancelation resource or DL preemption resource is indicated within UL subband or DL subband are described herein. The methods can effectively enable UL/DL inter-UE multiplexing mechanism under full duplex cases. Transmission performance can be improved for high-priority service transmission to improve user experience and overall network performance.

Some arrangements relate to transmission multiplexing mechanisms between different UEs under full duplex, including indicating UL cancelation resource within an UL subband. In some examples, a cancelation resource indication set is defined, in which the BS 102 indicates to the UE 104 the cancelation resource. The BS 102 and the UE 104 can each determine the cancelation resource indication set in the manner described herein.

FIG. 6 is a flowchart diagram illustrating an example method 600 for indicating UL cancelation resource, according to various arrangements. The method 600 can be performed using the system 100 (e.g., the UE 104 and a network including the BS 102).

At 610, the network (e.g., the BS 102) sends to the UE 104 information indicating that at least a part of a frequency-domain resource of at least one of a DL resource (e.g., the resources 320 and 330) or a flexible resource (e.g., the resource 340) is configured as an UL resource (e.g., the UL subband 360). At 620, the UE 104 receives from the BS 102 the information indicating that at least a part of the frequency-domain resource of at least one of the DL resource or the flexible resource is configured as an UL resource.

At 630, the network (e.g., the BS 102) determines based on the information a cancelation resource indication set. At 640, the UE 104 determines based on the information a cancelation resource indication set.

At 640, the network (e.g., the BS 102) sends to the UE 104 an indication of a cancelation resource within the cancelation resource indication set. At 650, the UE 104 receives from the BS 102 the indication of the cancelation resource within the cancelation resource indication set.

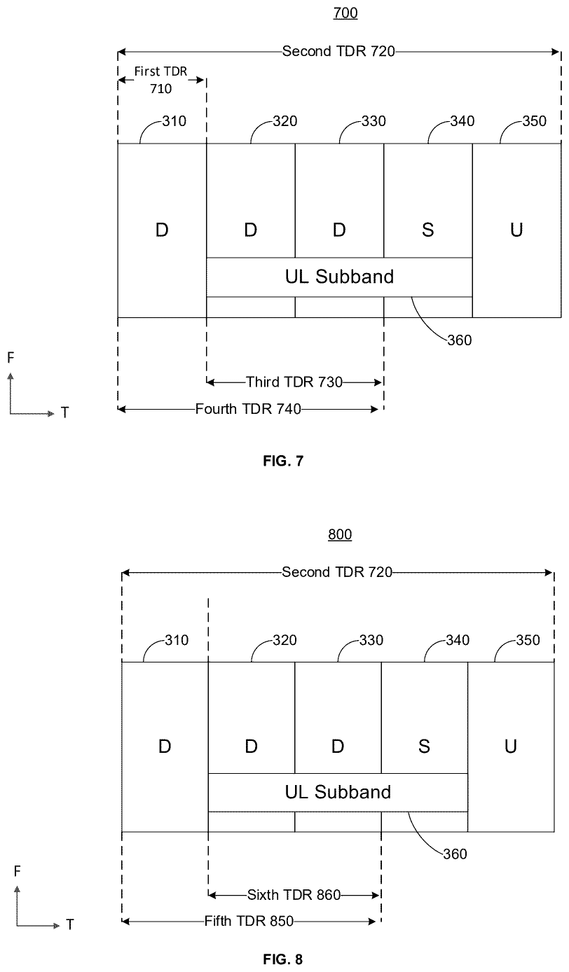

FIG. 7 is a schematic diagram illustrating an example of a semi-static frame structure 700, according to various arrangements. The semi-static frame structure 700 can be used by multiple UEs (e.g., the UE 104) within a same cell (e.g., the cell 126) under a BS (e.g., the BS 102). The semi-static frame structure 700 includes resources 310, 320, 330, 340, and 350 as described relative to FIG. 3. The UL subband 360 is configured by the BS 102 to the UE 104 in the DL resources 320 and 330 and the flexible resource 340.

In some examples, the TDR of the cancelation resource indication set can be determined by excluding a first TDR 710 from a second TDR 720. The second TDR can be a time domain duration configured or defined for cancelation resource indication set. In the method 600, the BS 102 and the UE 104 can each determine a TDR of the cancelation resource indication set by excluding the first TDR from the second TDR. The first TDR is determined by excluding a third TDR from a fourth TDR. The fourth TDR is configured as the DL resource or a Synchronization Signal/Physical Broadcast Channel (PBCH) Block (SSB) transmission resource by the network. The third TDR is a part of the fourth TDR which is configured with the uplink resource, wherein the UL resource includes an UL subband. In some examples, the first TDR can include a DL resource without any configured UL resource (e.g., without any UL subband). In some examples, the first TDR can include a flexible resource configured for SSB transmission without any configured UL resource (e.g., without any UL subband). In some examples, the BS 102 sends to the UE 104 and the UE 104 receives from the BS 102 high layer signaling configuring the fourth TDR as the DL resource or the SSB transmission resource. The high layer signaling includes RRC signaling.

In some examples, the second TDR 720 represents that a time domain duration configured by the BS 102 to the UE 104 using a high layer signaling, e.g., RRC signaling. In some examples, the second TDR 720 equals to a default time-domain duration. For example, the default time-domain duration is determined according to (e.g., equal to) a Physical Downlink Control Channel (PDCCH) monitoring periodicity. In some examples, the first TDR 710 is defined by excluding a third TDR 730 configured with the UL subband 360 from a fourth TDR 740 configured by the BS 102 to the UE 104 as DL resource (e.g., the DL resources 310, 320, and 330) by a high layer signaling, e.g., RRC signaling, tdd-UL-DL-ConfigurationCommon, or an SSB transmission resource, and so on. In the example shown in FIG. 7, the second TDR 720 contains resources 310, 320, 330, 340, and 350 (e.g., each of which can be a slot), which are configured as “DDDSU” as described relative to FIG. 3.

The fourth TDR 740 is defined as at least one DL resource (e.g., the DL resources 310, 320, and 330). The third TDR 730 is defined as a TDR configured with the UL subband 360 under at least one DL resource. As shown, the third TDR 730 contains the resources 320 and 330, each of which is a slot. Accordingly, the first TDR 710 is determined by excluding the third TDR 730 from the fourth TDR 740. The first TDR 710 contains the resource 310, which is a slot. Therefore, the TDR of the cancelation resource indication set includes resources 320, 330, 340, and 350.

FIG. 8 is a schematic diagram illustrating an example of a semi-static frame structure 800, according to various arrangements. The semi-static frame structure 800 can be used by multiple UEs (e.g., the UE 104) within a same cell (e.g., the cell 126) under a BS (e.g., the BS 102). The semi-static frame structure 800 includes resources 310, 320, 330, 340, and 350 as described relative to FIG. 3. The UL subband 360 is configured by the BS 102 to the UE 104 in the DL resources 320 and 330 and the flexible resource 340.

In some examples, the second TDR 720 represents that a time-domain duration configured by the BS 102 to the UE 104 using a high layer signaling, e.g., RRC signaling. In some examples, the second TDR 720 equals to a default time-domain duration. For example, the default time-domain duration is determined according to (e.g., equal to) a Physical Downlink Control Channel (PDCCH) monitoring periodicity. In some examples, the fifth TDR 850 is defined as DL resource configured by a high layer signaling, e.g., RRC signaling. In some examples, if there are a part (e.g., a sixth TDR 860) of the fifth TDR 850 configured with the UL subband 360, that part of fifth TDR 850 configured with the UL subband 360, which is the sixth TDR 860) is reserved in the TDR of the cancelation resource indication set. That is, the TDR 860 configured with the UL subband 360 is not excluded from the TDR of the cancelation resource indication set.

As shown in FIG. 8, the second TDR 720 contains resources 310, 320, 330, 340, and 350 (e.g., each of which can be a slot), which are configured as “DDDSU” as described relative to FIG. 3. The fifth TDR 850 is defined as a DL resource, including resources 310, 320, and 330, of the second TDR 720. Then, the fifth TDR 850 is excluded from the TDR of the cancelation resource indication set. Further, within the DL resource (e.g., the fifth TDR 850), the UL subband 360 is configured on the resources 320 and 330, each of which is a slot. These resources, denoted as the sixth TDR 860, are added back to the TDR of the cancelation resource indication set. That is, the TDR of the cancelation resource indication set contains, resources 320, 330, 340, and 350, each of which is a slot.

In the method 600, a TDR (e.g., the sixth TDR 860) within the DL resource or the flexible resource is configured with the UL resource (e.g., the UL subband 360). The TDR (e.g., the sixth TDR 860) is entirely within a TDR of the cancelation resource indication set.

In some examples, at least one TDR within a flexible resource is configured for Synchronization Signal/Physical Broadcast Channel (PBCH) Block (SSB) transmission in response to determining that at least a part or a portion of the at least one TDR is also configured with the UL subband. The at least a part of the TDR is reserved in the TDR of the cancelation resource indication set. On the other hands, in response to determining that none of the at least one TDR is configured with a UL subband, the TDR configured for SSB transmission is excluded from the TDR of the cancelation resource indication set. In the method 600, a TDR within the flexible resource or the DL resource is configured for receiving by UE 104 from the network (e.g., the BS 102) an SSB. At least a portion of the TDR within the flexible resource is configured with an UL resource (e.g., an UL subband). The at least the portion of the TDR within the flexible resource is within the TDR of the cancelation resource indication set.

In some examples, at least one TDR within a DL resource is configured for SSB transmission in response to determining that at least a part or a portion of the at least one TDR is also configured with the UL subband. The at least a part of the TDR is reserved in the TDR of the cancelation resource indication set. On the other hands, in response to determining that none of the at least one TDR is configured with a UL subband, the TDR configured for SSB transmission is excluded from the TDR of the cancelation resource indication set. In the method 600, a TDR within the DL resource is configured for receiving by UE 104 from the network (e.g., the BS 102) an SSB. At least a portion of the TDR within the DL resource is configured with UL subband. The at least the portion of the TDR within the DL resource is within the TDR of the cancelation resource indication set.

In some examples, the FDR of the cancelation resource indication set equals to the bandwidth of the UL Bandwidth Part (BWP). In some examples, the FDR of the cancelation resource indication set is configured by a high layer signaling, e.g., a RRC signaling. In some examples, the FDR of the cancelation resource indication set equals to the bandwidth of the UL resource (e.g., the UL subband). In some examples, the FDR of the cancelation resource indication set is determined according to the time-domain starting position of the cancelation resource indication set. In some examples, two or more candidate FDR of the cancelation resource indication set are defined. One of the two or more candidate FDR is selected according to a time-domain starting position of the cancelation resource indication set.

In the example in which the time domain starting position of the cancelation resource indication set is located at a DL symbol configured with UL subband, the FDR of the cancelation resource indication set equals to a first frequency region, e.g., the bandwidth of the UL subband or a frequency region configured by a first high layer signaling. In the example in which the time domain starting position of the cancelation resource indication set is located at a symbol of UL slot or flexible slot, the FDR of the cancelation resource indication set equals to a second frequency region, e.g., the bandwidth of the UL BWP or a frequency region configured by a second high layer signaling.

In the example in which the time domain starting position of the cancelation resource indication set is located at a symbol configured with UL subband, the FDR of the cancelation resource indication set equals to a first frequency region, e.g., the bandwidth of the UL subband or a frequency region configured by a first high layer signaling. In the example in which the time domain starting position of the cancelation resource indication set is located at a symbol of UL slot or a flexible symbol without SSB transmission and is not configured with UL subband, the FDR of the cancelation resource indication set equals to a second frequency region, e.g., the bandwidth of the UL BWP or a frequency region configured by a second high layer signaling.

In the example in which he time domain starting position of the cancelation resource indication set is located at a symbol configured with UL subband and the symbol is a DL symbol or a flexible symbol configured with SSB transmission, the FDR of the cancelation resource indication set equals to a first frequency region, e.g., the bandwidth of the UL subband or a frequency region configured by a first high layer signaling. In the example in which the time domain starting position of the cancelation resource indication set is located at a UL symbol or a flexible symbol without SSB transmission, the FDR of the cancelation resource indication set equals to a second frequency region, e.g., the bandwidth of the UL BWP or a frequency region configured by a second high layer signaling.

Some arrangements relate to enabling transmission multiplexing mechanism between different UEs under full duplex, including indicating an UL cancelation resource within an UL subband.

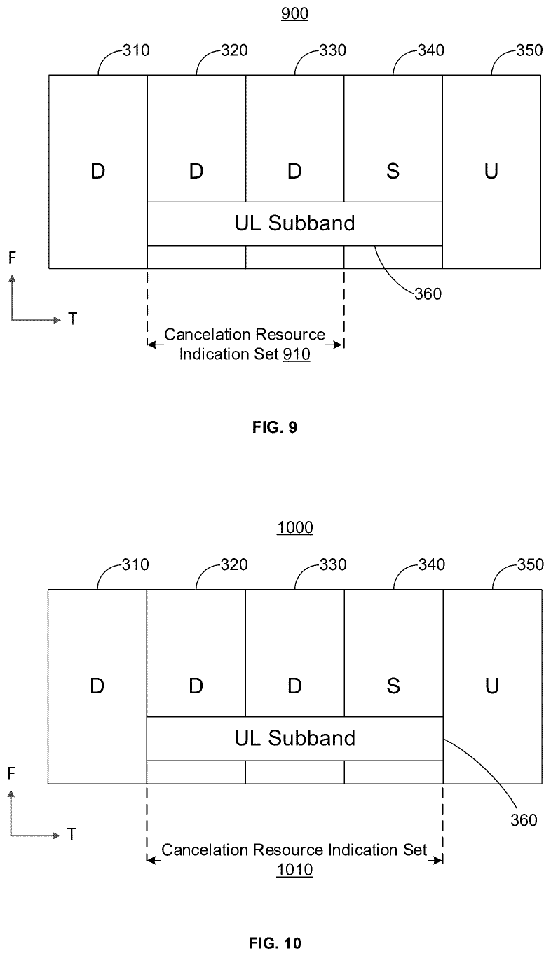

FIG. 9 is a schematic diagram illustrating an example of a semi-static frame structure 900, according to various arrangements. The semi-static frame structure 900 can be used by multiple UEs (e.g., the UE 104) within a same cell (e.g., the cell 126) under a BS (e.g., the BS 102). The semi-static frame structure 900 includes resources 310, 320, 330, 340, and 350 as described relative to FIG. 3. The UL subband 360 is configured by the BS 102 to the UE 104 in the DL resources 320 and 330 and the flexible resource 340. In FIG. 9, the time domain duration includes five resources 310, 320, 330, 340, and 350, each of which can be a slot, which are configured as “DDDSU” as described relative to FIG. 3. The time-domain duration or the configured TDR, similar to the second TDR 720, is configured by the BS 102 to the UE 104 using a high layer signaling, e.g., RRC signaling. In some examples, the configured TDR or the time-domain duration equals to a default time-domain duration. For example, the default time-domain duration is determined according to a PDCCH monitoring periodicity.

In some examples, a cancelation resource indication set 910 is determined as configured UL subband resource on DL resource within a time-domain duration. A part or a portion of the FDR of the middle three resources 320, 330, and 340 are configured as the UL subband 360. The resource configured for UL subband within DL resource is determined as the cancelation resource indication set, e.g., resources 320 and 330. Thus, in some arrangements, the UE 104 and the BS 102 can determine that the cancelation resource indication set as the UL resource (e.g., an UL subband) on the DL resource within a time-domain duration, which is the configured TDR. The configured TDR, similar to the second TDR 720, is configured by the BS 102 to the UE 104 using a high layer signaling, e.g., RRC signaling. In some examples, the configured TDR or the time-domain duration equals to a default time-domain duration. For example, the default time-domain duration is determined according to a PDCCH monitoring periodicity.

FIG. 10 is a schematic diagram illustrating an example of a semi-static frame structure 1000, according to various arrangements. The semi-static frame structure 1000 can be used by multiple UEs (e.g., the UE 104) within a same cell (e.g., the cell 126) under a BS (e.g., the BS 102). The semi-static frame structure 1000 includes resources 310, 320, 330, 340, and 350 as described relative to FIG. 3. The UL subband 360 is configured by the BS 102 to the UE 104 in the DL resources 320 and 330 and the flexible resource 340. In FIG. 10, the time domain duration includes five resources 310, 320, 330, 340, and 350, each of which can be a slot, which are configured as “DDDSU” as described relative to FIG. 3. The time-domain duration or the configured TDR, similar to the second TDR 720, is configured by the BS 102 to the UE 104 using a high layer signaling, e.g., RRC signaling. In some examples, the configured TDR or the time-domain duration equals to a default time-domain duration. For example, the default time-domain duration is determined according to a PDCCH monitoring periodicity.

In some examples, a cancelation resource indication set 1010 is determined as resource configured for UL subband within a time domain duration. A part or a portion of the FDR of the middle three resources 320, 330, and 340 are configured as the UL subband 360. The resource configured for UL subband 360 is determined as the cancelation resource indication set 1010 that includes the resources 320, 330, and 340. Thus, in some arrangements, the UE 104 and the BS 102 can determine the cancelation resource indication set as a resource configured for the UL resource (e.g., an UL subband) within a time-domain duration.

FIG. 11 is a schematic diagram illustrating an example of a semi-static frame structure 1100, according to various arrangements. The semi-static frame structure 1100 can be used by multiple UEs (e.g., the UE 104) within a same cell (e.g., the cell 126) under a BS (e.g., the BS 102). The semi-static frame structure 1100 includes resources 310, 320, 330, 340, and 350 as described relative to FIG. 3. The UL subband 360 is configured by the BS 102 to the UE 104 in the DL resources 320 and 330 and the flexible resource 340. In FIG. 11, the time domain duration includes five resources 310, 320, 330, 340, and 350, each of which can be a slot, which are configured as “DDDSU” as described relative to FIG. 3. The time-domain duration or the configured TDR, similar to the second TDR 720, is configured by the BS 102 to the UE 104 using a high layer signaling, e.g., RRC signaling. In some examples, the configured TDR or the time-domain duration equals to a default time-domain duration. For example, the default time-domain duration is determined according to a PDCCH monitoring periodicity.

In some examples, a cancelation resource indication set 1110 is determined as configured UL subband resource on DL resource or flexible resource with SSB transmission within a time domain duration. A part or a portion of the FDR of the middle three resources 320, 330, and 340 are configured as the UL subband 360. An SSB is configured to be transmitted in the flexible resource 340 in an SSB resource 1120. The resource configured for UL subband 360 within DL resource contains two parts of TDR, including the resources 320 and 330 and any SSB symbols (e.g., the SSB resource 1120) within the resource 340. Thus, in some arrangements, the UE 104 and the BS 102 can determine the cancelation resource indication set as at least one UL resource (e.g., an UL subband) on at least one DL resource or at least one flexible resource (e.g., at least a part thereof) configured for SSB within a time-domain duration.

In some examples, the FDR of the cancelation resource indication set equals to the bandwidth of the UL subband.

In some examples, for indicating cancelation resource within both UL subband and UL BWP of a same carrier or cell, two or more indication blocks (e.g., two) in one UL CI for a carrier or a cell can be used. In some examples, the two or more indication blocks corresponds to a same configured time-domain duration or range of a cancelation resource indication set. One of the two or more indication blocks indicates a first resource set of the cancelation resource indication set. Another one of the two or more indication blocks indicates a second resource set of the cancelation resource indication set. In some examples the first resource set does not overlap with the second resource set in the time domain. For example, the first resource set contains the TDR that configured UL subband resource on DL resource or flexible resource with SSB transmission within the cancelation resource indication set. The TDR of the second resource set is determined by excluding DL resource and flexible resource for SSB transmission from the configured time-domain duration of the cancelation resource indication set.

Thus, in some arrangements, two or more indication blocks are in an UL CI for a carrier. The two or more indication blocks correspond to a same time-domain duration of the cancelation resource indication set. A first indication block of the two or more indication blocks indicates a first resource set of the cancelation resource indication set. A second indication block of the two or more indication blocks indicates a second resource set of the cancelation resource indication set. In some examples, the first resource set and the second resource set are non-overlap in a time domain.

In some examples, the first resource set and the second resource set overlap in a time domain, for example, the second resource set contains the first resource set in the time domain. More specifically, the first resource set contains the TDR that configured UL subband resource on DL resource or flexible resource with SSB transmission within the cancelation resource indication set. The TDR of the second resource set is determined by excluding DL resource without configured UL subband and flexible resource for SSB transmission and without configured UL subband from the configured time-domain duration of the cancelation resource indication set. Thus, in some arrangements, two or more indication blocks are in an UL CI for a carrier. The two or more indication blocks correspond to a same time-domain duration of the cancelation resource indication set. A first indication block of the two or more indication blocks indicates a first resource set of the cancelation resource indication set. A second indication block of the two or more indication blocks indicates a second resource set of the cancelation resource indication set. In some examples, the second resource set comprises the first resource set in a time domain.

In some examples, different configuration parameters (such as at least one of, number of time domain partition, frequency domain region, number of bits for the indication block in the DCI, bit position of the indication block in the DCI) for determining the time-frequency domain sub-blocks partition or indication information in the DCI are used for the first resource set and the second resource set respectively. In some examples, a same configuration parameters for determining the time-frequency domain sub-blocks partition or indication information in the DCI are used for both of the first resource set and the second resource set. Thus, in some arrangements, the UE 104 and the BS 102 determines time-frequency domain sub-block partitions of both the first resource set and the second resource set according to a same set of configuration parameters.

Some arrangements relate to transmission multiplexing mechanism between different UEs under full duplex, including indicating an UL cancelation resource within an UL subband.

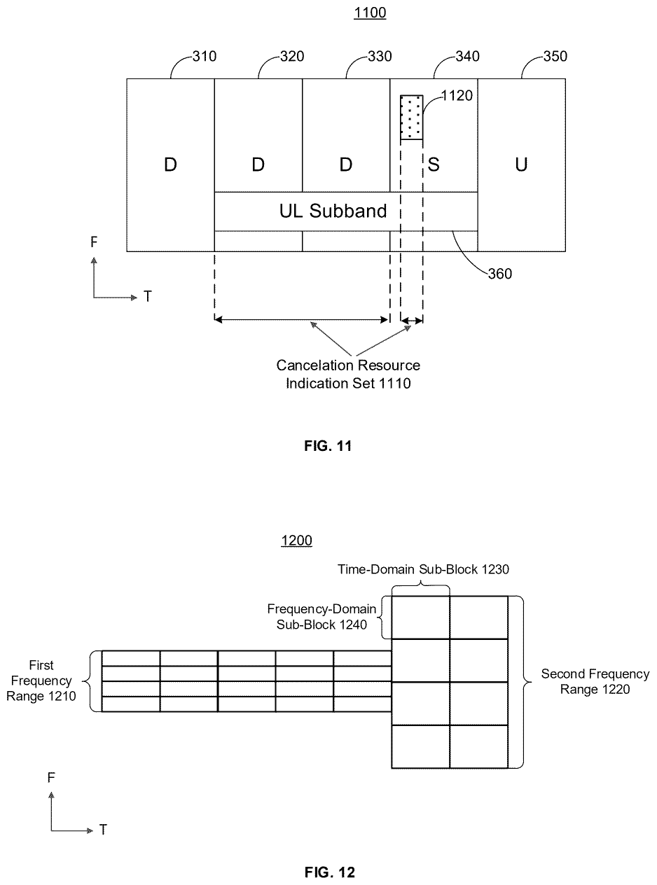

FIG. 12 is a diagram illustrating an example cancelation resource indication set 1200, according to various arrangements. In some examples, two or more frequency granularities are defined for different time domain sub-blocks within one cancelation resource indication set 1200. Thus, in some arrangements, the cancelation resource indication set includes two or more time-domain sub-blocks. The two or more time-domain sub-blocks are defined by two or more frequency granularities.

As shown in FIG. 12, the cancelation resource indication set 1200 is divided into N (e.g., 7) time-domain sub-blocks 1230 according to the signaling indication received by the UE 104 from the BS 102, initially. Then, in the examples in which 28 bits are configured for indication overhead, each of the time-domain sub-blocks 1230 can be divided into M (e.g., 28/7=4) frequency-domain sub-blocks 1240. Accordingly, the cancelation resource indication set 1200 includes 28 time-frequency sub-blocks total. For the first five time-domain sub-blocks, the frequency-domain range of the cancelation resource indication set equals to the first frequency range 1210 (e.g., X Physical Resource Blocks (PRBs)), so the frequency granularity is X/M PRBs. For the last two time-domain sub-blocks, the frequency domain range of the cancelation resource indication set equals to the second frequency range 1220 (e.g., Y PRBs), so the frequency granularity is Y/4 PRBs.

In some examples, at least one of X and Y is not a multiple of the number of frequency-domain sub-blocks 1240 (i.e., 4). The frequency granularity can be defined can be otherwise defined. For example, for the first frequency range 1210, the first M−X+└X/M┘*M frequency-domain sub-blocks includes └X/M┘ PRBs and each of the remaining X−└X/M┘*M frequency domain sub-blocks includes ┌X/M┐ PRBs. For example, assuming X=17 PRBs, M=4, the first M−X+└X/M┘*M=4−17+└17/4┘*4=3 frequency domain sub-blocks includes └X/M┘=4 PRBs. The remaining one frequency domain sub-block has ┌X/M┐=5 PRBs.

In some examples, the bandwidth of UL subband can be defined as the first frequency range. The bandwidth of UL BWP can be defined as the second frequency range. FIG. 13 is a diagram illustrating an example cancelation resource indication set 1300, according to various arrangements. In some examples, one or more time-domain sub-blocks 1330 may cross different frequency ranges. In some arrangements, a time-domain sub-block of the two or more time-domain sub-blocks crosses two or more frequency ranges with different frequency granularities. As shown in FIG. 13, both of the first frequency range 1310 and the second frequency range 1320 coexisting within the fifth time-domain sub-block of the time-domain sub-blocks 1330. To define the frequency granularity for this time-domain sub-block, in some examples, the largest bandwidth of the different frequency range related with a time domain sub-block can be used for determining the frequency granularity of the time domain sub-block to divide it into different frequency domain sub-blocks.

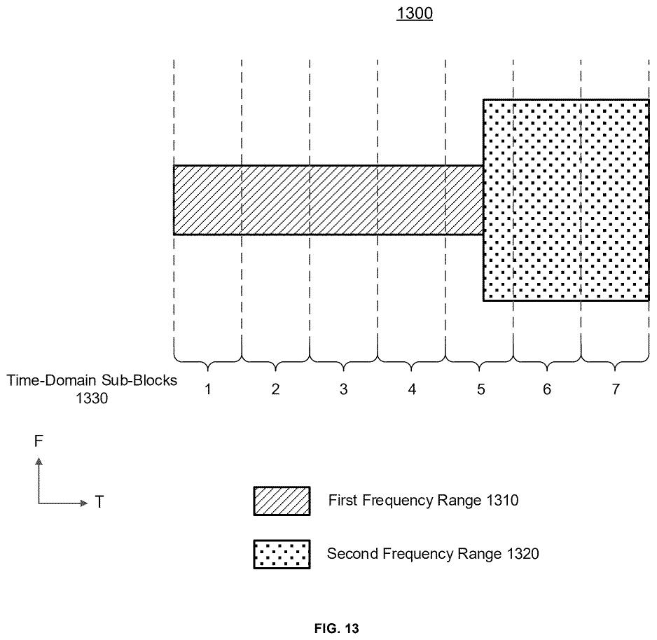

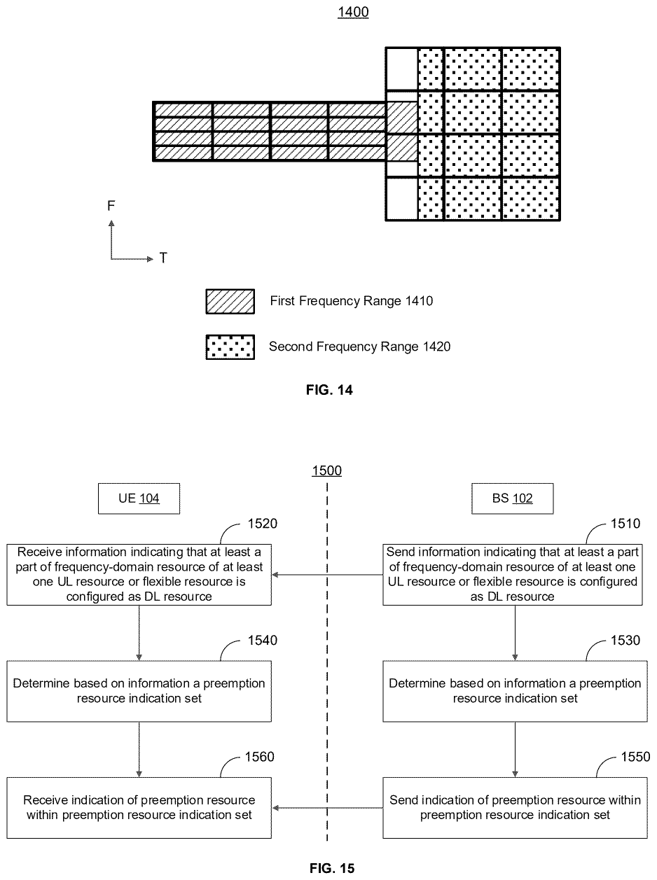

FIG. 14 is a diagram illustrating an example cancelation resource indication set 1400, according to various arrangements. In some examples, one frequency range is UL subband, and another frequency range is UL BWP. The bandwidth of UL BWP can be used for determined the frequency granularity. As shown in FIG. 14, the bandwidth of the second frequency range 1420 can be used for determining the frequency granularity. In some examples, the bandwidth of UL subband is defined as the first frequency range 1410, the bandwidth of the UL BWP is defined as the second frequency range 1420. The bandwidth of the UL BWP can be used for determining the frequency granularity.

Thus, in some arrangements, the largest bandwidth of the two or more frequency ranges of the time-domain sub-block is used to determine a frequency granularity of the time-domain sub-block. The frequency granularity of the time-domain sub-block divides the time-domain sub-block into a plurality of frequency-domain sub-blocks. In some arrangements, a first frequency range of the two or more frequency ranges comprises an UL resource (e.g., an UL subband). A second frequency range of the two or more frequency ranges comprises an UL BWP. The second frequency range is used to determine the frequency granularity of the time-domain sub-block.

In some arrangements, for indicating cancelation resource within both UL subband and UL BWP of a same carrier, two or more indication blocks (e.g., two) in one UL CI for a carrier. In some examples, the two or more indication blocks corresponds to a same configured time domain range of a cancelation resource indication set. One of the two or more indication blocks indicates a first resource set of the cancelation resource indication set. Another one of the two or more indication blocks indicates a second resource set of the cancelation resource indication set. In some examples, the first resource set completely includes the second resource set in time domain. Thus, in some arrangements, two or more indication blocks are in an UL CI for a carrier. The two or more indication blocks correspond to a same time-domain range of the cancelation resource indication set. A first indication block of the two or more indication blocks indicates a first resource set of the cancelation resource indication set. A second indication block of the two or more indication blocks indicates a second resource set of the cancelation resource indication set. The first resource set and the second resource set are non-overlap in a time domain in some examples.

For example, the TDR of the first resource set is determined by excluding DL resource without UL subband from configured TDR of the cancelation resource indication set. The TDR of the second resource set is determined by excluding DL resource and resource for SSB transmission from the configured time domain duration of the cancelation resource indication set. In some examples, different configuration parameters for determining the time-frequency domain sub-blocks partition are used for the first resource set and the second resource set respectively. In some examples, a same configuration parameters for determining the time-frequency domain sub-blocks partition are used for both of the first resource set and the second resource set. Thus, in some arrangements, the UE 104 or the BS 102 determines time-frequency domain sub-block partitions of both the first resource set and the second resource set according to a same set of configuration parameters.

Some arrangements relate to enabling transmission multiplexing mechanism between different UEs under full duplex, including indicating DL preemption resource within DL subband.

In some examples, a part of FDR of semi-static UL resource or flexible resource can be configured as DL resource, which can also be referred to as a DL subband. Similar to UL cancelation indication, a time domain duration or range of preemption resource indication set can be determined via a signaling from the BS 102 to the UE 104 or a predefined value. The TDR of the preemption resource indication set is determined by excluding UL resource from the time domain duration of preemption resource indication set. Then, the preemption resource indication set can be divided into time-frequency domain sub-blocks. A DL Preemption Indication (DL PI) can be used by the BS 102 to indicate to the UE 104 the preemption resource from the preemption resource indication set. So according to the conventional mechanism, a preemption resource cannot be indicated by the DL PI as the UL resource had been excluded from the preemption resource indication set.

In some examples, the TDR of the preemption resource indication set can be defined by excluding UL resource without DL subband from the time domain duration of the preemption resource indication set. In some examples, the TDR of the preemption resource indication set can be defined by a UL resource configured with DL subband within the time domain duration of preemption resource indication set. In some examples, the FDR of the preemption resource indication set equals to the bandwidth of the DL subband.

In some examples, the FDR of the preemption resource indication set is determined according to the time-domain starting position of the preemption resource indication set. In the example in which the time domain starting position of the preemption resource indication set is located at a UL symbol configured with DL subband, the FDR of the preemption resource indication set equals to a first frequency region, e.g., the bandwidth of the DL subband or a frequency region configured by a first high layer signaling. In the examples in which the time-domain starting position of the preemption resource indication set is located at a symbol of DL slot or flexible slot, the FDR of the preemption resource indication set equals to a second frequency region, e.g., the bandwidth of the DL BWP or a frequency region configured by a second high layer signaling.

In the examples in which the time-domain starting position of the preemption resource indication set is located at a symbol configured with DL subband, the FDR of the preemption resource indication set equals to a third frequency region, e.g., the bandwidth of the UL subband or a frequency region configured by a first high layer signaling. In the examples in which the time domain starting position of the preemption resource indication set is located at a symbol of UL slot, the FDR of the preemption resource indication set equals to a fourth frequency region, e.g., the bandwidth of the UL BWP or a frequency region configured by a second high layer signaling.

In some examples, for indicating preemption resource within both DL subband and DL BWP of a same carrier, two or more indication blocks (e.g., two) are in one UL PI for a carrier or a cell. In some examples, the two or more indication blocks corresponds to a same configured or defined time-domain range or duration of a preemption resource indication set, and one of the two or more indication blocks indicates a first resource set of the preemption resource indication set. Another one of the two or more indication blocks indicates a second resource set of the preemption resource indication set. In some examples, the first resource set does not overlap with the second resource set in the time domain. In some examples, the first resource set completely includes the second resource set in the time domain. In some examples, a same configuration parameters for determining the time-frequency domain sub-blocks partition are used for both of the first resource set and the second resource set.

In some examples, two or more frequency granularities are defined for different time domain sub-blocks within one preemption resource indication set.

In some examples, two or more time-domain sub-block may cross different frequency ranges. In some examples, the largest bandwidth of the different frequency ranges that relates to a time-domain sub-block can be used for determining the frequency granularity of the time domain sub-block to divide the time domain sub-block into different frequency domain sub-blocks. In some examples, one frequency range is DL subband, and another frequency range is DL BWP. The bandwidth of DL BWP can be used for determining the frequency granularity.

FIG. 15 is a flowchart diagram illustrating an example method 1500 for indicating UL cancelation resource, according to various arrangements. The method 1500 can be performed using the system 100 (e.g., the UE 104 and a network including the BS 102).

At 1510, the network (e.g., the BS 102) sends to the UE 104 information indicating that at least a part of frequency domain resource of at least one of a UL resource or a flexible resource is configured as a DL resource. At 1520, the UE 104 receives from the BS 102 the information indicating that the DL resource is configured within at least one of the UL resource or the flexible resource.

At 1530, the network (e.g., the BS 102) determines based on the information a preemption resource indication set. At 1540, the UE 104 determines based on the information a preemption resource indication set.

At 1540, the network (e.g., the BS 102) sends to the UE 104 an indication of a preemption resource within the preemption resource indication set. At 1550, the UE 104 receives from the BS 102 the indication of the preemption resource within the preemption resource indication set.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program (e.g., a computer program product) or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the arrangements described in this disclosure will be readily apparent to those skilled in the art, and the general principles defined herein can be applied to other arrangements without departing from the scope of this disclosure. Thus, the disclosure is not intended to be limited to the arrangements shown herein, but is to be accorded the widest scope consistent with the novel features and principles disclosed herein, as recited in the claims below.

1. A wireless communication method, comprising:
receiving, by a wireless communication device from a network, information indicating that at least a part of frequency domain resource of at least one of a Downlink (DL) resource or a flexible resource is configured as an Uplink (UL) resource;
determining, by the wireless communication device based on the information, a cancelation resource indication set; and
receiving, by the wireless communication device from the network, an indication of a cancelation resource within the cancelation resource indication set.

2. The wireless communication method of claim 1, further comprising determining, by the wireless communication device, a Time Domain Resource (TDR) of the cancelation resource indication set by excluding a first TDR from a second TDR.

3. The wireless communication method of claim 2, wherein the first TDR is determined by excluding a third TDR from a fourth TDR, wherein the fourth TDR is configured as the DL resource or Synchronization Signal/Physical Broadcast Channel (PBCH) Block (SSB) transmission resource by the network, the third TDR is a part of the fourth TDR which is configured with the UL resource, wherein the UL resource comprises an UL subband.

4. The wireless communication method of claim 3, further comprising receiving, by the wireless communication device from the network, high layer signaling configuring the fourth TDR as the DL resource or the SSB transmission resource, wherein the high layer signaling comprises Radio Resource Control (RRC) signaling.

5. The wireless communication method of claim 1, wherein
a TDR within the DL resource or the flexible resource is configured with the UL resource; and
the TDR is entirely within a TDR of the cancelation resource indication set.

6. The wireless communication method of claim 1, wherein
a TDR within the flexible resource or the DL resource is configured for receiving by the wireless communication device from the network a Synchronization Signal/Physical Broadcast Channel (PBCH) Block (SSB);
at least a portion of the TDR within the flexible resource is configured with an UL resource; and
the at least the portion of the TDR within the flexible resource is within the TDR of the cancelation resource indication set.

7. The wireless communication method of claim 1, wherein a Frequency Domain Resource (FDR) of the cancelation resource indication set equals to a bandwidth of the UL resource.

8. The wireless communication method of claim 1, wherein a Frequency Domain Resource (FDR) of the cancelation resource indication set is determined according to a time-domain starting position of the cancelation resource indication set.

9. The wireless communication method of claim 8, wherein two or more candidate FDR of the cancelation resource indication set are defined, and one of the two or more candidate FDR is selected according to a time-domain starting position of the cancelation resource indication set.

10. The wireless communication method of claim 1, further comprising determining, by the wireless communication device, the cancelation resource indication set as the Uplink (UL) resource on the Downlink (DL) resource within a time-domain duration.

11. The wireless communication method of claim 1, further comprising determining, by the wireless communication device, the cancelation resource indication set as a resource configured for the Uplink (UL) resource within a time-domain duration.

12. The wireless communication method of claim 1, further comprising determining, by the wireless communication device, the cancelation resource indication set as at least one Uplink (UL) resource on at least one Downlink (DL) resource or at least one flexible resource configured for Synchronization Signal/Physical Broadcast Channel (PBCH) Block (SSB) within a time-domain duration.

13. The wireless communication method of claim 10, wherein
two or more indication blocks are in an Uplink (UL) Cancelation Indication (CI) for a carrier;
the two or more indication blocks correspond to a same time-domain duration of the cancelation resource indication set;
a first indication block of the two or more indication blocks indicates a first resource set of the cancelation resource indication set;
a second indication block of the two or more indication blocks indicates a second resource set of the cancelation resource indication set; and
the first resource set and the second resource set are non-overlapping in a time domain.

14. The wireless communication method of claim 10, wherein
two or more indication blocks are in an Uplink (UL) Cancelation Indication (CI) for a carrier;
the two or more indication blocks correspond to a same time-domain duration of the cancelation resource indication set;
a first indication block of the two or more indication blocks indicates a first resource set of the cancelation resource indication set;
a second indication block of the two or more indication blocks indicates a second resource set of the cancelation resource indication set; and
the second resource set comprises the first resource set in a time domain.

15. The wireless communication method of claim 13, further comprising determining, by the wireless communication device, time-frequency domain sub-block partitions of both the first resource set and the second resource set according to a same set of configuration parameters.

16. The wireless communication method of claim 1, wherein
the cancelation resource indication set comprises two or more time-domain sub-blocks; and
the two or more time-domain sub-blocks are defined by two or more frequency granularities.

17. The wireless communication method of claim 16, wherein a time-domain sub-block of the two or more time-domain sub-blocks crosses two or more frequency ranges with different frequency granularities.

18. A wireless communication method, comprising:
sending, by a network to a wireless communication device, information indicating that at least a part of at least one of a Downlink (DL) resource or a flexible resource is configured as an uplink resource;
determining, by the network based on the information, a cancelation resource indication set; and
sending, by the network to the wireless communication device, an indication of a cancelation resource within a cancelation resource indication set.

19. A wireless communication device, comprising:
at least one processor configured to:
receive, via a receiver from a network, information indicating that at least a part of frequency domain resource of at least one of a Downlink (DL) resource or a flexible resource is configured as an Uplink (UL) resource;
determine, based on the information, a cancelation resource indication set; and
receive, via the receiver from the network, an indication of a cancelation resource within the cancelation resource indication set.

20. A network node, comprising:
at least one processor configured to:
send, via a transmitter to a wireless communication device, information indicating that at least a part of at least one of a Downlink (DL) resource or a flexible resource is configured as an uplink resource;
determine, based on the information, a cancelation resource indication set; and
send, via the transmitter to the wireless communication device, an indication of a cancelation resource within a cancelation resource indication set.
